(19) United States
(12) Patent Application Publication
(10) Pub. No.: US 2026/0048372 A1
(43) Pub. Date: Feb. 19, 2026

(54) BLENDER SYSTEM

(71) Applicant: STEWART & STEVENSON LLC, Houston, TX (US)

(72) Inventors: Ricardo RODRIGUEZ-RAMON, Houston, TX (US); Nicholas TEW, Houston, TX (US)

(21) Appl. No.: 19/265,487

(22) Filed: Jul. 10, 2025

Related U.S. Application Data
(60) Provisional application No. 63/682,641, filed on Aug. 13, 2024.

(51) Int. Cl. B01F 35/71; B01F 23/50; B01F 23/53; B01F 27/906; B01F 35/32; B01F 35/33; B01F 35/45; B01F 35/75; B01F 101/49

(52) U.S. Cl. CPC B01F 35/717; B01F 23/53; B01F 23/565; B01F 27/906; B01F 35/3204; B01F 35/33; B01F 35/45; B01F 35/712; B01F 35/7544; B01F 2101/49

(57) ABSTRACT

A blender system may include a blender assembly, the blender assembly including a blender tub, the blender tub having a mixing chamber and an open top. The blender assembly may also include one or more paddles, the paddles positioned within the mixing chamber and a tub paddle motor, the tub paddle motor adapted to rotatably drive the one or more paddles. The blender assembly may also include an upper lip, the upper lip positioned within the blender tub and a shroud, the shroud extending from the upper lip. In addition, the blender system may include a flow surface, the flow surface positioned below the shroud forming a flow channel between the shroud and the flow surface.

### CROSS-REFERENCE TO RELATED APPLICATIONS

This application is a nonprovisional application which claims priority from U.S. provisional application No. 63/682,641, filed Aug. 13, 2024, which is incorporated by reference herein in its entirety.

### TECHNICAL FIELD/FIELD OF THE DISCLOSURE

The present disclosure relates generally to blender systems for mixing fracturing fluids.

### BACKGROUND OF THE DISCLOSURE

During completion and production operations, fluids are circulated through a wellbore. Various chemicals are introduced into the fluids, referred to herein as the slurry, to produce slurry having desirable characteristics.

### SUMMARY

A blender system for mixing fracturing fluids is disclosed. The blender system may include a blender assembly, the blender assembly including a blender tub, the blender tub having a mixing chamber and an open top. The blender assembly may also include one or more paddles, the paddles positioned within the mixing chamber and a tub paddle motor, the tub paddle motor adapted to rotatably drive the one or more paddles. The blender assembly may also include an upper lip, the upper lip positioned within the blender tub and a shroud, the shroud extending from the upper lip. In addition, the blender system may include a flow surface, the flow surface positioned below the shroud forming a flow channel between the shroud and the flow surface.

A method is disclosed. The method may include supplying a blender system, the blender system including a blender tub, the blender tub having an open top, an upper lip and a base and a shroud, the shroud extending from the upper lip. The blender system may also include a flow surface, the flow surface positioned below the shroud forming a flow channel between the shroud and the flow surface. In addition, the method may include forming a mixed/mixing material slurry within the blender tub, the mixed/mixing material slurry having a fluid surface. Further, the method may include introducing an unmixed material into the blender tub below the fluid surface of the mixed/mixing material within the blender tub.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a schematic of a blender system consistent with at least one embodiment of the present disclosure.

FIG. 2 depicts a cutaway side view of a blender tub consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

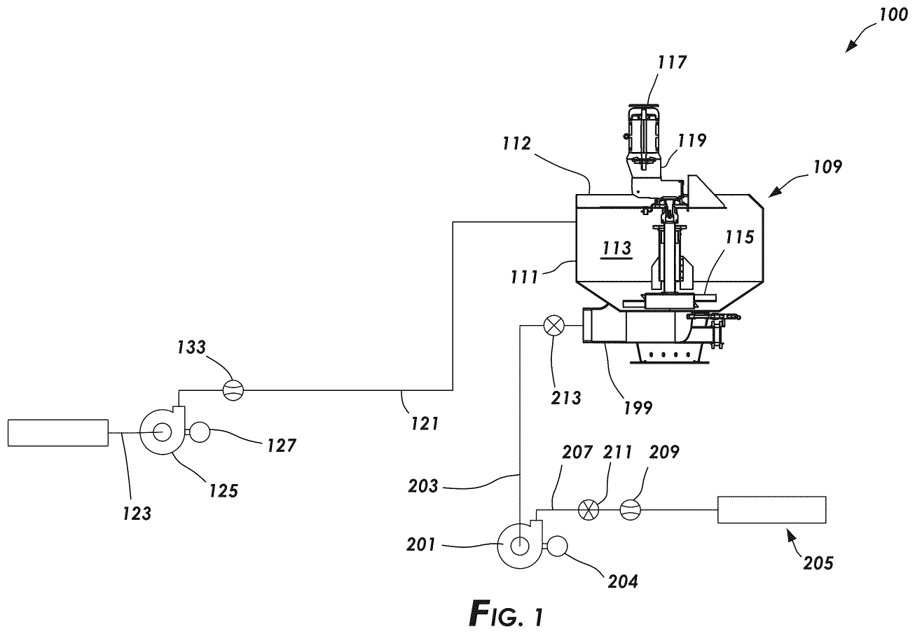

FIG. 1 depicts blender system 100. Blender system 100 may be used to prepare fluids for use in wellbore operations including stimulation operations such as hydraulic fracturing operation. For the purposes of this disclosure and without any intent to limit the scope of this disclosure, the fluids prepared by blender system 100 are referred to herein as a slurry made up of ingredients, chemicals, products, and base fluids as understood in the art such as, for example and without limitation, friction reducer, high viscosity friction reducer, guar or synthetic gel, inhibitors, PH buffers, and biocides.

Blender system 100 may include blender assembly 109. Blender assembly 109 may be adapted to mix one or more ingredients, chemicals, and products with a base fluid to generate a slurry used, for example and without limitation, in a wellbore stimulation operation such as a hydraulic fracturing operation. Blender assembly 109 may include blender tub 111, which defines mixing chamber 113. Blender tub 111 may be a vessel into which ingredients, chemicals, products, and base fluids may be introduced and mixed. In some embodiments, blender assembly 109 may include one or more blender paddles 115 positioned within mixing chamber 113 and rotatably driven by tub paddle motor 117. In some embodiments, tub paddle motor 117 may be an electric motor. In some embodiments, tub paddle motor 117 may operatively couple to blender paddles 115 via paddle gearbox 119. Blender paddles 115 may, as they rotate within mixing chamber 113, agitate and mix the ingredients, chemicals, products, and base fluids introduced thereinto to prepare the slurry. In certain embodiments, blender tub 111 may include open top 112 where air may enter blender tub 111.

In some embodiments, base fluids may be introduced into blender tub 111 via supply pipe 121 coupled thereto. In some embodiments, supply pipe 121 may be fluidly coupled to suction manifold 123 via suction pump 125. Suction pump 125 may be driven by suction pump motor 127. In some embodiments, suction pump motor 127 may be an electric motor. In some embodiments, suction pump 125 may be used to draw fluids such as base fluids from external tanks or reservoirs through suction manifold 123 and pump the fluids into mixing chamber 113 through supply pipe 121. In some embodiments, flow meter 133 may be positioned on supply pipe 121 to, for example and without limitation, measure the amount of fluid provided to mixing chamber 113 by suction pump 125.

In some embodiments, blender tub 111 may include outlet 199 positioned at the base of blender tub 111. Outlet 199 may be fluidly coupled to discharge pump 201 by outlet pipe 203. Discharge pump 201 may be driven by discharge pump motor 204. In some embodiments, discharge pump motor 204 may be an electric motor. Discharge pump 201 may be fluidly coupled to discharge manifold 205. Discharge pump 201 may be operated to pump slurry from blender tub 111 to discharge manifold 205 via discharge pipe 207, from which slurry may be piped to other wellsite equipment for use in a wellbore. In some embodiments, outlet pipe 203 or discharge pipe 207 may include discharge flow meter 209 and discharge densitometer 211 positioned to measure the flow rate and density, respectively, of slurry pumped through discharge pump 201. In some embodiments, outlet pipe 203 or discharge pipe 207 may include valve 213 positioned to allow or prevent flow of slurry from blender tub 111. In some embodiments, valve 213 may be pneumatically, hydraulically, or electrically actuated.

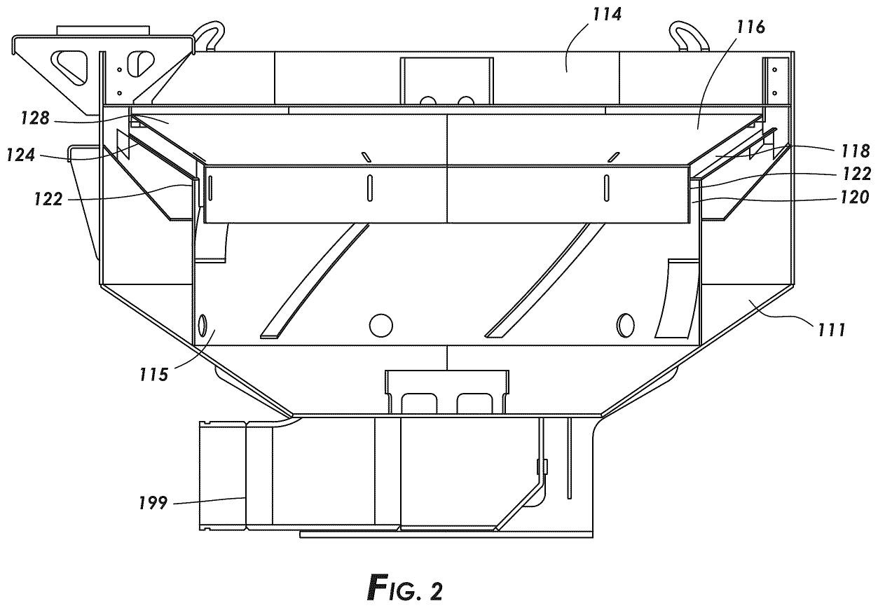

Open top 112 of blender tub 111 increases the entry of air into blender tub 111, especially if unmixed material entering blender tub 111 enter above the surface of the mixed/mixing materials within blender tub 111. FIG. 2 depicts upper lip 114 positioned within blender tub 111. Extending from upper lip 114 may be shroud 116. Shroud 116 may encourage turbulent flow within blender tub 111; in certain embodiments, shroud 116 may be adapted to cause turbulent flow within blender tub 111. Turbulent flow may be preferred to laminar flow because the friction and agitation of turbulent flow may facilitate proppant suspension in the slurry. Shroud 116 also may provide reinforcement to maintain the structural integrity of blender tub 111. Shroud 116 may extend circumferentially around the inside of blender tub 111. Further, shroud 116 may include downward-facing lip 120. Downward-facing lip 120 may extend towards the bottom of blender tub 111 from upper surface 128 of shroud 116.

In some embodiments, positioned below upper surface 128 of shroud 116 is flow surface 124. Flow surface 124 extends circumferentially around the inside of blender tub 111 below that of upper surface 128 of shroud 116. Flow channel 118 is the gap between flow surface 124 and upper surface 128. Unmixed materials entering blender tub 111 may flow through flow channel 118. In certain embodiments, unmixed material entering blender tub 111 enters below the fluid surface 122 of the mixed/mixing materials slurry within blender tub 111.

The reduction of air entrainment into blender tub 111 increases the efficiency and performance of blender tub 111, as well as the operational life of discharge pump 201, as discharge pump 201 is working to move only materials for which it was designed and not excess air.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A blender system for mixing fracturing fluids comprising:
a blender assembly, the blender assembly including:
a blender tub, the blender tub having a mixing chamber and an open top;
one or more paddles, the paddles positioned within the mixing chamber;
a tub paddle motor, the tub paddle motor adapted to rotatably drive the one or more paddles;
an upper lip, the upper lip positioned within the blender tub;
a shroud, the shroud extending from the upper lip;
a flow surface, the flow surface positioned below the shroud and forming a flow channel between the shroud and the flow surface.

2. The blender system of claim 1, wherein the shroud extends circumferentially about the inside of the blender tub.

3. The blender system of claim 1, wherein the flow surface extends circumferentially around the inside of the blender tub.

4. The blender system of claim 1, wherein the flow channel is adapted to inject an unmixed fluid below the level of a mixed fluid within the blender tub.

5. The blender system of claim 4, wherein the shroud includes a downward-facing lip that extends towards a bottom of the blender tub.

6. The blender system of claim 1, wherein the blender tub includes an outlet positioned at a base of the blender tub.

7. The blender system of claim 1 further comprising a discharge pump, the discharge pump coupled to an outlet pipe connected to the outlet.

8. The blender system of claim 1 further comprising a supply pipe, the supply pipe adapted to provide base fluids to the blender system.

9. The blender system of claim 1 further comprising a paddle gearbox, the paddle gearbox operatively coupling the blender paddles to the tub paddle motor.

10. A method comprising:
supplying a blender system, the blender system including:
a blender tub, the blender tub having an open top, an upper lip and a base;
a shroud, the shroud extending from the upper lip; and
a flow surface, the flow surface positioned below the shroud forming a flow channel between the shroud and the flow surface;
forming a mixed/mixing material slurry within the blender tub, the mixed/mixing material slurry having a fluid surface; and
introducing an unmixed material into the blender tub below the fluid surface of the mixed/mixing material within the blender tub.

11. The method of claim 10, wherein the introducing an unmixed material into the blender tub comprises flowing the unmixed material through the flow channel.

12. The method of claim 10, wherein the shroud extends circumferentially about the inside of the blender tub.

13. The method of claim 10, wherein the flow surface extends circumferentially around the inside of the blender tub.

14. The method of claim 10, wherein the shroud includes a downward-facing lip that extends towards a bottom of the blender tub.
